(19) United States
(12) Patent Application Publication
(10) Pub. No.: US 2016/0050182 A1
(43) Pub. Date: Feb. 18, 2016

(54) Diverting Traffic for Forensics

(71) Applicant: Cisco Technology Inc., San Jose, CA (US)

(72) Inventor: Naasief Edross, Cary, NC (US)

(21) Appl. No.: 14/460,127

(22) Filed: Aug. 14, 2014

(51) Int. Cl. H04L 29/06

(52) U.S. Cl. CPC H04L 63/0272; H04L 63/1425

(57) ABSTRACT

In one embodiment of a method, system and apparatus for diverting anomalous traffic from a host, the method, system and apparatus are described including detecting malicious traffic and communications by an endpoint agent included in a network host, the malicious traffic and communications directed from the network host to an IP address, the IP address being stored in a reputation database, sending a signal to a central server by a signaling mechanism included in the endpoint agent, the signal indicating detection of traffic directed from the network host to the IP address, the signal triggering creation of a split tunnel virtual private network (VPN) policy on a VPN server controlled by the central server, and receiving instructions at a receiver included in the endpoint agent from the VPN server to join a VPN group.

### TECHNICAL FIELD

The present disclosure generally relates to network security.

### BACKGROUND

When a network host is infected by malware, the network traffic and communications flowing between the infected host to a malicious host, and particularly the outgoing network traffic and communications, is blended in with the flow of non-malicious network traffic and communications.

### BRIEF DESCRIPTION OF THE DRAWINGS

The present invention will be understood and appreciated more fully from the following detailed description, taken in conjunction with the drawings in which:

FIG. 1 is a simplified block diagram illustration of a system for diverting anomalous traffic and communications from a host constructed and operative in accordance with an embodiment of the present invention;

FIG. 2 is a simplified block diagram illustration of the host of FIG. 1;

FIG. 3 is a simplified block diagram illustration of the system of FIG. 1, where one host on a network is communicating with a malicious host;

FIG. 4 is a simplified block diagram drawing of the system of FIG. 1, where the one host on the network which was communicating with the malicious host is now tunneling the those communications to a different location; and

FIG. 5 is a flowchart diagram of a method of implementing the system of FIG. 1.

### DESCRIPTION OF EXAMPLE EMBODIMENTS

### Overview

A method, system and apparatus for diverting anomalous traffic from a host, the method, system and apparatus including detecting malicious traffic and communications by an endpoint agent included in a network host, the malicious traffic and communications directed from the network host to an IP address, the IP address being stored in a reputation database, sending a signal to a central server by a signaling mechanism included in the endpoint agent, the signal indicating detection of traffic directed from the network host to the IP address, the signal triggering creation of a split tunnel virtual private network (VPN) policy on a VPN server controlled by the central server, and receiving instructions at a receiver included in the endpoint agent from the VPN server to join a VPN group.

### Exemplary Embodiment

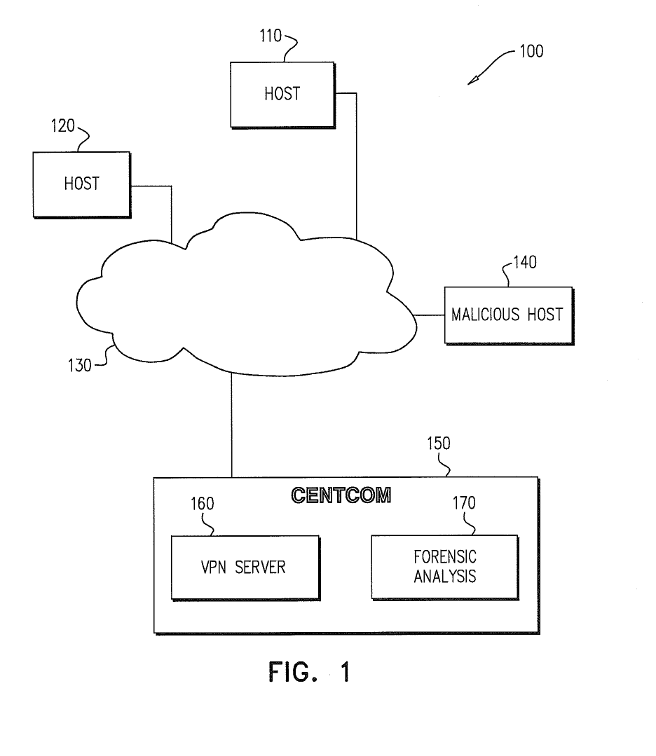

Reference is now made to FIG. 1, which is a simplified block diagram illustration of a system 100 for diverting anomalous traffic and communications from a host constructed and operative in accordance with an embodiment of the present invention. A plurality of hosts 110, 120 are connected to a network 130. The hosts may comprise any computing device connected to the network 130, including, but not limited to a mainframe computer, a server, a desktop or laptop computer, a tablet computer, or other handheld computing device. The network 130 may comprise either a private network or a public network, such as the Internet.

At least one malicious host 140 is also connected to the network 130.

Additionally, a central server, CentCom 150 (i.e. Central Communications, a central overarching authority) is located on the network. CentCom 150 controls a VPN server 160 and maintains a forensic analysis and investigation system 170. It is appreciated that CentCom 150 may either be enterprise based, cloud based, or partially enterprise based and partially cloud based. CentCom is a central intelligence agent that is able to orchestrate a set of actions based on the desire of the network owner, and may control other threat management entities on the network 130, such as advanced malware protection sandboxes, and so forth. CentCom can control the VPN server 160, and the forensic analysis and investigation system 170 amongst other systems. CentCom is the chief orchestrator that receives updates about what action has been observed on the host and what action the host 110, 120 is going to be subjected to. CentCom has 2-way communication with components such as the VPN server 160 and the forensic analysis and investigation system 170.

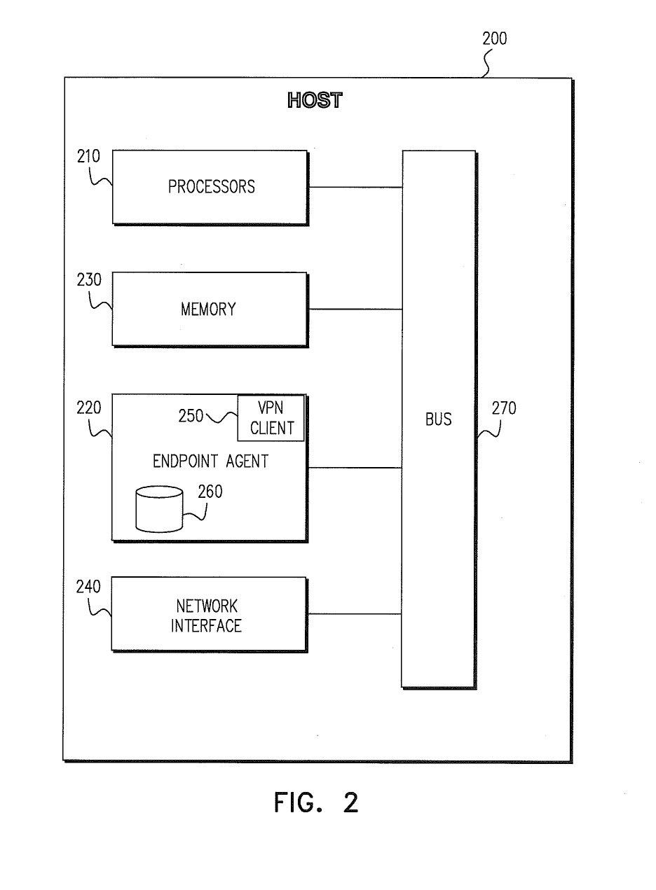

Reference is now made to FIG. 2, which is simplified block diagram illustration of the one of the hosts 110, 120 of FIG. 1, designated in FIG. 2 as host 200.

The host 200 comprises at least one processor 210, and may comprise more than one processor 210. One of the processors 210 may be a special purpose processor operative, together with an endpoint agent 220, described below, to perform the detection and diversion of anomalous traffic and communications from the host 200, according to the method described herein. In addition, the host 200 comprises non-transitory computer-readable storage media, i.e., memory 230. The memory 230 may store instructions, which at least one of the processors 210 may execute, in order to perform the method of detection and diversion of anomalous traffic and communications from the host 200 described herein. Host 200 also comprises typical and standard hardware and software components as are known in the art.

The endpoint agent 220 mentioned above, monitors incoming and outgoing network connections destined to and originating from all the active Network Interface Cards (NICs) and / or any other appropriate interface 240 that carries an IPv4 or IPv6 address on the host 200. The endpoint agent 220 also comprises a virtual private network (VPN) client 250, which is operative to receive instructions from the VPN server 160 (FIG. 1).

The endpoint agent 220 receives updates from cloud based servers which monitor malicious IP addresses that are known to be command-and-control or malicious sources and destinations. The updates are stored in a reputation database 260 of malicious IP addresses maintained by the endpoint agent 220. This reputation database 260 is referred to hereinafter as the “watch list”. It is appreciated that these updates can be sent either by pushing them or by pulling them to the endpoint agent 220.

In some alternative embodiments of the invention, if traffic and communications over the network interface 240 is either to or from an IP address not found in the reputation database 260, then the endpoint agent 220 queries the cloud based servers to see if the IP address has been added to the database since the reputation database 260 of endpoint agent 220 received its last update from the cloud based servers. The endpoint agent 220 is also able to cache the result of this query for a configurable amount of time.

The host 200 comprises a communications bus 270 in order to facilitate communications between the various components described above which comprise the host 200.

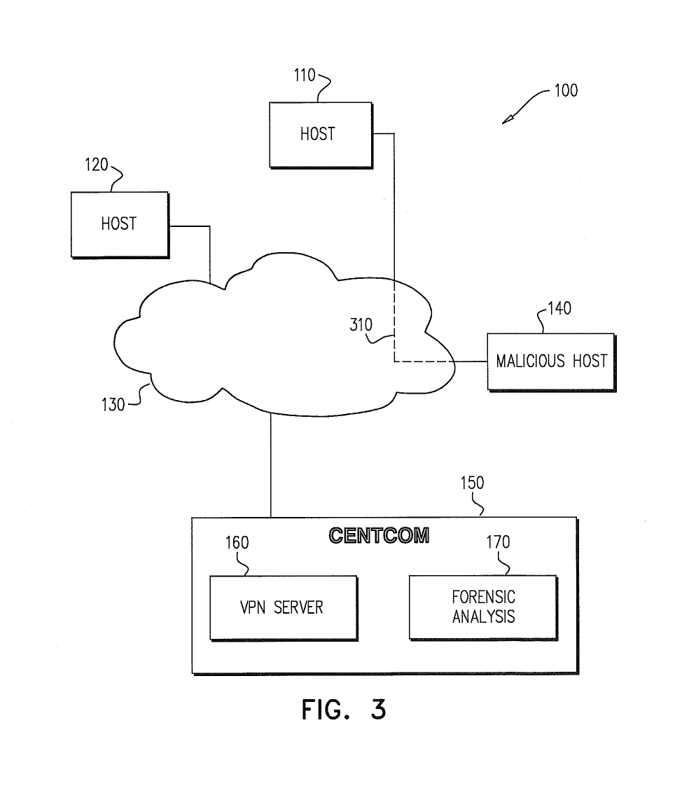

Reference is now made to FIG. 3, which is a simplified block diagram illustration of the system 100 of FIG. 1, where one host 110 on the network 130 is communicating with the malicious host 140.

When the endpoint agent 220 (FIG. 2) detects that the infected host 110 is communicating 310 with a host having an IP address which is on the watch list, such as the malicious host 140, a signaling mechanism (not depicted) comprised in the endpoint agent 220 (FIG. 2) sends a signal to CentCom 150 indicating detection of traffic and communications directed to the IP address which is on the watch list. More specifically, the signal indicates that the endpoint agent 220 (FIG. 2) has detected communications traffic between the host 110 on which the endpoint agent 220 (FIG. 2) is resident and a host having an IP address which is on the watch list (i.e. the malicious host 140).

It is appreciated that lists of IP addresses and URLs which are known to be associated with malicious sites or malware are available on the Internet (i.e. the Cloud). The endpoint agent 220 (FIG. 2) either receives updates from time-to-time from services which monitor the Internet for IP addresses and URLs which are known to be associated with malicious sites or malware, and makes lists of those IP addresses and URLs which are known to be associated with malicious sites or malware available. Examples of such lists of IP addresses and URLs which are known to be associated with malicious sites or malware include, but are not limited to Cisco Security Intellegence Operations (SIO) and Sourcefire Vulnerability Research Team (VRT).

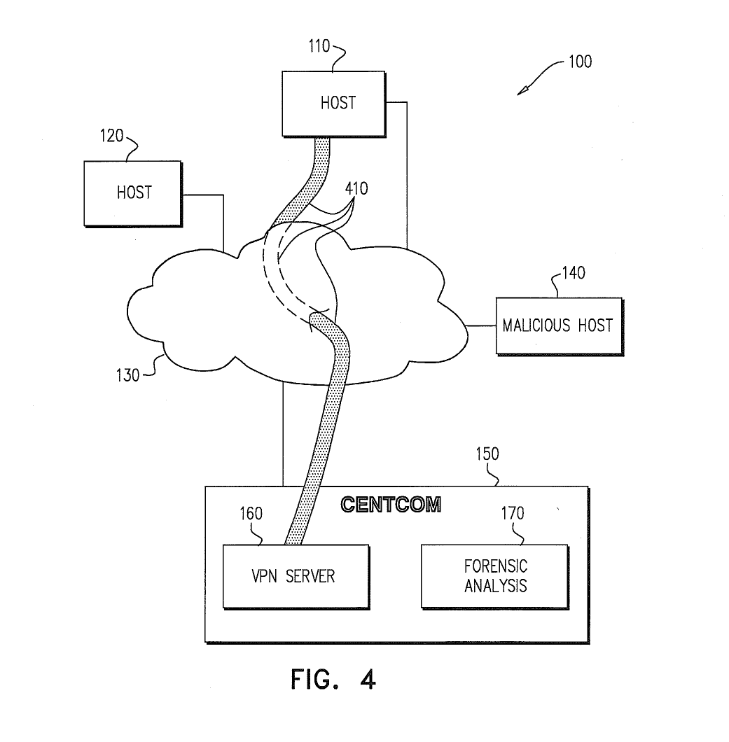

Reference is now made to FIG. 4, which is a simplified block diagram drawing of the system 100 of FIG. 1, where the one host 110 on the network 130 which was in communication 310 (FIG. 3) with the malicious host 140 is now tunneling that communication 310 (FIG. 3) to a different location through a VPN 410. When CentCom 150 receives the signal from the endpoint agent 220 (FIG. 2) indicating detection of the communication 310 (FIG. 3) between the host 110 and the malicious host 140, the VPN server 160 of CentCom 150 triggers creation of a VPN group policy (which might, for the sake of example, be entitled INVESTIGATION) with a split tunnel attribute so that the traffic and communications from the host 110 is directed to CentCom 150 instead of the malicious host 140. Other network traffic and communications from the host 110 is unaffected by the VPN group policy.

CentCom 150 receives notification from the VPN server 160 that the VPN server 160 is now provisioned to tunnel the communication 310 (FIG. 3) back to the VPN server 160. That is to say, once the VPN server 160 is provisioned with the INVESTIGATION group there is now acknowledgement at CentCom 150 that the detection has been tracked, as have associated remedial actions and timestamps, so that the detected connection can be used for investigative purposes. Upon receipt of the notification, CentCom 150 notifies the VPN client 250 of the endpoint agent 220 (FIG. 2) to establish the VPN 410 to the VPN server 160 and join the group INVESTIGATION.

Upon the endpoint agent 220 (FIG. 2) receiving the notification from CentCom 150, the endpoint agent 220 (FIG. 2) verifies the notification using any appropriate cross-network messaging and validation system incorporated into the design of the network 130. One such system might be Cisco® PxGrid, a single protocol system, commercially available from Cisco® Systems, Inc. 170 West Tasman Drive, San Jose, Calif. 95134. Cisco® PxGrid enables multivendor, cross-platform network system collaboration among parts of the IT infrastructure such as security monitoring and detection systems, network policy platforms, asset and configuration management, identity and access management platforms, and virtually any other IT operations platform. Cisco® PxGrid enables, when operational needs arise, participants in the network 130, such as hosts 110, 120, and CentCom 150 to share information with platforms using Cisco® PxGrid.

Alternatively or additionally, verification may be performed using certificate based authentication, which has been built into the provisioning of the host 110, 120.

Once the notification from CentCom 150 has been verified by the endpoint agent 220 (FIG. 2), the endpoint agent 220 (FIG. 2) transparently establishes a VPN 410 connection back to the VPN server 160 using one of the secure socket layer (SSL) or the datagram transport layer security (DTLS) protocols using certificated-based authentication.

Communications which are directed to the IP address which appears on the watch list (i.e. to the malicious host 140) are now diverted, via the VPN 410, to the forensic analysis and investigation system 170 of CentCom 150. On the other hand, traffic and communications not directed to the IP address which are not found in the reputation database (i.e. which are not on the watch list) is not routed via the VPN 410, but proceeds along its normal route. For example, communication between host 110 and host 120 proceed normally through the network 130.

The VPN 410 is established, even though the endpoint agent 220 (FIG. 2) maintains the watch list. Keeping the VPN 410 open all of the time in anticipation of future potentially malicious traffic and communications is wasteful of resources, both of the host 110 and of the VPN server 160. Additionally, by signaling CentCom 150, the endpoint agent 220 (FIG. 2) allows CentCom 150 the option of not establishing the VPN 410. Thus, a selective mechanism may be established. It is appreciated that the VPN 410 may be established at later or earlier times as well. However, in some embodiments of the present invention, the establishment of the VPN 410 is optimal once communications are to be diverted via the VPN 410.

By way of example, if the endpoint agent 220 (FIG. 2) in the host 110 was located at a financial agency and was to see traffic and communications directed to an IP address on the watch list, and the watch list source rates this IP address with high-fidelity as a confirmed threat, then it may be appropriate to ignore additional forensic analysis, and take other steps to eliminate the connection with the malicious host 140. It is appreciated that the term “high-fidelity” as used herein is used to indicate that more than one external reputation database or a privately maintained reputation database, such as one of Structured threat Information Expression (STIX) and Trusted Automated eXchange of Indicator Information (TAXII), has recorded this IP address as being malicious. Alternatively, the IP address is considered to be malicious with high-fidelity if the Financial Services-Information Sharing and Analysis Center (FS-ISAC) issues an alert in which the IP address is identified as being malicious.

It is appreciated that the communications 310 is routed through the VPN 410 in order to avoid exposing those communications 310 designated for forensic analysis to the Internet. By utilizing the VPN 410, the host 110 can be anywhere in the world in IPv4 or IPv6 space, the class of suspicious communications 310 (as deemed worthy for redirection and analysis by a threat operator) can always be directed to the enterprise's corporate (and shielded from the Internet) private sandbox and forensic analysis system through a secure transport medium. The data comprising an indicator of compromise (IOC, i.e. an artifact observed that with high confidence is indicative of an intrusion on the host 110) is not shared and viewable with packet captures due to the data being encapsulated inside the VPN 410 tunnel. This allows corporations to control the disclosure and sharing of the IOC if the IOC happened to be taking place in clear-text communication such as HTTP or FTP.

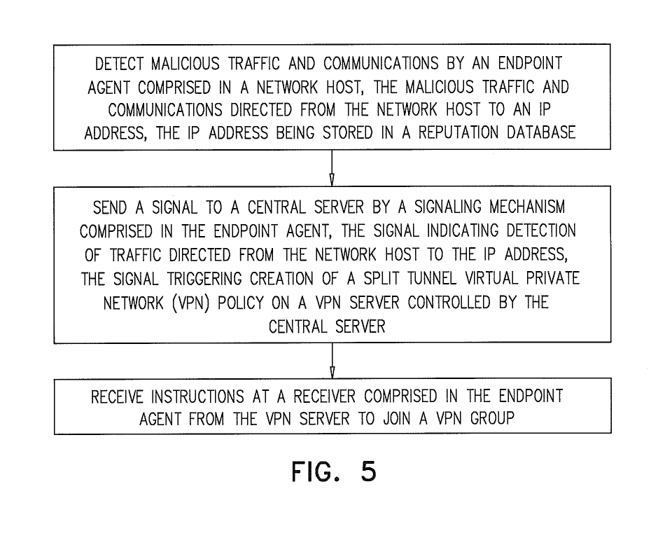

Reference is now made to FIG. 5, which is a flowchart diagram of a method of implementing the system of FIG. 1. FIG. 5 is believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system for diverting anomalous traffic from a host, the system comprising:
a network host comprising an endpoint agent that detects malicious traffic and communications, the malicious traffic and communications directed from the network host to an IP address, the IP address being stored in a reputation database;
the endpoint agent comprising a signaling mechanism that sends a signal to a central server, the signal indicating detection of traffic directed from the network host to the IP address, the signal triggering creation of a split tunnel virtual private network (VPN) policy on a VPN server controlled by the central server; and
the endpoint agent comprising a receiver that receives instructions from the VPN server to join a VPN group.

2. The system according to claim 1 wherein the endpoint agent is directed to tunnel the traffic directed to the IP address stored in the reputation database to a second server controlled by the central server.

3. The system according to claim 2 wherein the traffic directed to the second server is directed via a split tunnel VPN.

4. The system according to claim 2 wherein traffic not directed to the IP address stored in the reputation database is not routed to the second server.

5. The system according to claim 1 wherein the central server comprises the VPN server.

6. The system according to claim 1 wherein a split tunnel VPN tunnel is activated for the VPN group.

7. The system according to claim 6 wherein the VPN may be selectively established.

8. The system according to claim 6 wherein the split tunnel VPN utilizes a secure socket layer (SSL) protocol.

9. The system according to claim 6 wherein the split tunnel VPN utilizes a datagram transport layer security (DTLS) protocol.

10. The system according to claim 1 wherein at least one of the central server and the VPN server comprise one of a cloud based server and an enterprise based server.

11. A method for diverting anomalous traffic from a host, the method comprising:
detecting malicious traffic and communications by an endpoint agent comprised in a network host, the malicious traffic and communications directed from the network host to an IP address, the IP address being stored in a reputation database;
sending a signal to a central server by a signaling mechanism comprised in the endpoint agent, the signal indicating detection of traffic directed from the network host to the IP address, the signal triggering creation of a split tunnel virtual private network (VPN) policy on a VPN server controlled by the central server; and
receiving instructions at a receiver comprised in the endpoint agent from the VPN server to join a VPN group.

12. The method according to claim 11 wherein the endpoint agent is directed to tunnel the traffic directed to the IP address in the reputation database to a second server controlled by the central server.

13. The method according to claim 12 wherein the traffic directed to the second server is directed via a split tunnel VPN.

14. The method according to claim 12 wherein traffic not directed to the IP address in the reputation database is not routed to the second server.

15. The method according to claim 11 wherein the central server comprises the VPN server.

16. The method according to claim 11 wherein a split tunnel VPN tunnel is activated for the VPN group.

17. The method according to claim 16 wherein the VPN may be selectively established.

18. The method according to claim 16 wherein the split tunnel VPN utilizes one of: a secure socket layer (SSL) protocol; and a datagram transport layer security (DTLS) protocol.

19. The method according to claim 11 wherein at least one of the central server and the VPN server comprise one of a cloud based server and an enterprise based server.

20. A system for diverting anomalous traffic from a host, the system comprising:
means for detecting malicious traffic and communications by an endpoint agent comprised in a network host, the malicious traffic and communications directed from the network host to an IP address, the IP address being stored in a reputation database;
means for sending a signal to a central server by a signaling mechanism comprised in the endpoint agent, the signal indicating detection of traffic directed from the network host to the IP address, the signal triggering creation of a split tunnel virtual private network (VPN) policy on a VPN server controlled by the central server; and
means for receiving instructions at a receiver comprised in the endpoint agent from the VPN server to join a VPN group.
